(19) United States
(12) Patent Application Publication
(10) Pub. No.: US 2026/0050105 A1
(43) Pub. Date: Feb. 19, 2026

(54) SYSTEMS, METHODS, AND DEVICES FOR REDUCING LIGHT BLEED TRANSMITTED THROUGH A MATERIAL

(71) Applicant: Meta Platforms Technologies, LLC, Menlo Park, CA (US)

(72) Inventor: Jaykishan Dakshesh Choksi, Santa Clara, CA (US)

(21) Appl. No.: 19/301,832

(22) Filed: Aug. 15, 2025

Related U.S. Application Data
(60) Provisional application No. 63/684,820, filed on Aug. 19, 2024.

(51) Int. Cl. G02B 1/10; G02B 1/04; G02B 6/42; G02B 27/01

(52) U.S. Cl. CPC G02B 1/10; G02B 1/045; G02B 6/4203; G02B 6/4298; G02B 27/0172; G02B 2027/0178

(57) ABSTRACT

The present disclosure is directed to providing an optical device. The optical device includes a semi-transparent frame. The semi-transparent frame includes a light source configured to display a status of the optical device. Moreover, the semi-transparent frame includes a light guide configured to transmit light from the light source to an exterior surface of the semi-transparent frame. The semi-transparent frame further includes a coating adhered to the light guide and configured to limit leakage of the light to the semi-transparent frame such that only the light guide is illuminated. The coating is a type selected from a group of a low volatile organic compound coating, a non-conductive vacuum metallizing coating, and an organic water-based coating.

### RELATED APPLICATION

This application claims priority to U.S. Provisional Application Ser. No. 63/684,820, filed Aug. 19, 2024, entitled “Systems, Methods, And Devices For Reducing Light Bleed Transmitted Through A Material,” which is incorporated herein by reference.

### TECHNICAL FIELD

The present disclosure relates generally to optical devices, and, more specifically, to optical devices having an optical transparency and/or light-emitting features.

### BACKGROUND

Electronic devices are widely used in artificial reality and other light-guiding applications. In such use cases, electronic devices are generally fabricated with multiple layers and optical coatings, and incorporate various illuminating objects, such as power indicators. Some of these electronic devices tend to manipulate light emitted through and/or near the layers, such as through diffraction, refraction, bending, and/or the like. Moreover, the human eye tends to receive nearly one third of total light transmitted through the pupil periphery. As such, with near-eye electronic devices, light emitted from an illuminating object can cause eye or visual processing problems, such as blurred vision, tunnel vision, central vision loss, peripheral vision loss, halos, or the like. See Vasquez Quintero et al., 2020, “Artificial iris performance for smart contact lens vision correction applications,” Scientific Reports, 10(1), pg. 14641; Y. Barkhordar, 2015, “The Effects of Visual Deficiencies on the Task of Translation,” International Journal of Current Innovation Research, Vol. 1, Issue 8, pp. 170-183.

Given the above background, the art needs improved devices and compounds that discretely yet effectively and durably limit light transmission.

### SUMMARY

The present disclosure addresses the above-identified shortcomings.

(A1) This application describes optical devices. In accordance with some embodiments, an optical device includes a semi-transparent frame that includes a light source, such as a light-emitting diode. The semi-transparent frame further includes a light guide and a coating adhered to the light guide. The light guide is configured to transmit light from the light source to an exterior surface of the semi-transparent frame. Moreover, the coating is configured to limit leakage of the light to the semi-transparent frame such that only the light guide is illuminated. In some embodiments, the coating is a type selected from a group consisting of a low volatile organic compound (LVOC) coating, a non-conductive vacuum metallizing (NCVM) coating, and an organic water-based coating.

(A2) In some embodiments of A1, a thickness of the first coating ranges between 12 μm and 87 μm.

(A3) In some embodiments of A1, the NCVM type of coating comprises a primer coat, a UV basecoat, indium coat, polyurethane middle coat, UV topcoat with a total thickness ranging between 57 μm and 87 μm.

(A4) In some embodiments of A1, the LVOC type of coating comprises a metallic primer ranging between 12 μm and 16 μm.

(A5) In some embodiments of A4, the LVOC type of coating comprises a PU topcoat with a thickness ranging from 24 μm and 26 μm.

(A6) In some embodiments of any of A1-A5, the semi-transparent frame comprises a second coating adhered to the first coating.

(A7) In some embodiments of any of A1-A6, the LVOC type of coating comprises a metallic primer between 12 μm and 16 μm and a PU topcoat between 15 μm and 20 μm.

(A8) In some embodiments of A7, the second coating is an LVOC type of coating that comprises a metallic primer between 12 μm and 16 μm and a PU topcoat between 15 μm and 20 μm.

(A9) In some embodiments of any of A1-A8, the light guide emits light on a surface that faces a user's face when the optical device is donned.

(A10) In some embodiments of any of A1-A9, the light source is configured to convey information about the optical device to a user.

(A11) In some embodiments of any of A1-A10, the light source comprises a light-emitting diode.

(A12) In some embodiments of any of A1-A11, the light source comprises a substrate that limits light leakage from being presented on the opposite direction of where the light guide sends light.

(A13) In some embodiments of any of A1-A12, the light guide is separated by a PSA that limits light leakage between the light guide and a flexible printed circuit board.

(A14) In some embodiments of any of A1-A13, an exterior surface of the light guide is between 0.35 mm and 3.5 mm.

(A15) In some embodiments of any of A1-A13, the exterior surface of the light guide is between 2.5 mm and 0.65 mm.

(A16) In some embodiments of any of A1-A15, the light guide includes a nylon material.

(B1) Another aspect of the present disclosure is directed to providing a method of manufacture. The method includes providing a first shot of a semi-translucent material to a mold to produce a first portion of a frame of an optical device. The method includes inserting a flexible printed circuit board that includes a light source into a cavity of the first portion of the frame of the optical device. Furthermore, the method includes attaching a light guide that includes a coating that reduces light leakage to surrounding translucent material.

Moreover, the method includes providing a second shot of the semi-translucent material over a portion of the light guide to secure the light guide within the first portion of the frame of the optical device to thereby produce a frame for an optical device that includes a light guide.

(B2) In some embodiments of B1, the light guide is configured in accordance with any of A1-A15.

The disclosed optical devices and methods may replace conventional optical devices and methods. The disclosed optical devices and methods may complement conventional optical devices and methods.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an exemplary implementation of an optical device in accordance with some exemplary embodiments of the present disclosure.

FIG. 2 illustrates a system architecture of an optical device in accordance with some exemplary embodiments of the present disclosure.

FIG. 3 illustrates a view of an optical device including a light source in an on state in accordance with some exemplary embodiments of the present disclosure.

FIG. 4 is a view of an optical device including a light source having a light emitting diode in accordance with some exemplary embodiments of the present disclosure.

FIG. 5A is a view of an optical device including a light source in an ON state in accordance with some exemplary embodiments of the present disclosure.

FIG. 5B is a first cross-sectional view taken along line A-A of FIG. 5A.

FIG. 5C is an exploded view of the optical device of FIG. 5A.

FIG. 5D is a second cross-sectional view taken along line A-A of FIG. 5A.

FIGS. 6A and 6B collectively illustrate a light guide of an optical device in accordance with some embodiments of the present disclosure.

FIGS. 7A and 7B collectively illustrate another light guide of an optical device in accordance with some embodiments of the present disclosure.

FIG. 8 illustrates a flow chart of methods for manufacturing an optical device in accordance with some exemplary embodiments of the present disclosure.

FIG. 9 illustrates a chart depicting reflection information.

FIG. 10 illustrates a chart depicting exemplary logic function implemented using an optical device in accordance with some exemplary embodiments of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramhy (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

The present disclosure provides systems, methods, and devices for optical viewing, such as optical devices. In some embodiments, an optical device includes a semi-transparent frame, which allows for a wearer to wear the optical device when the optical device is in a powered, or on, state. Moreover, the optical device includes a light source that is configured to display a status of the optical device. Moreover, the semi-transparent frame includes a light guide configured to transmit light from the light source to an exterior surface of the semi-transparent frame, such as a first surface proximate to an eye of the wearer. In some embodiments, the semi-transparent frame further includes a coating adhered to the light guide. In some embodiments, the coating is configured to limit leakage of the light to the semi-transparent frame, such that only the light guide is illuminated. In some embodiments, the coating is a type selected from a group consisting of a low volatile organic compound coating, a non-conductive vacuum metallizing coating, and organic water-based coating. Accordingly, the optical device of the present disclosure allows for transmitting light emitted by the light source through the light guide toward the eye of the wearer, allowing the wearer to view the light source without hindrances or interferences.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

Plural instances may be provided for components, operations or structures described herein as a single instance. Finally, boundaries between various components, operations, and data stores are somewhat arbitrary, and particular operations are illustrated in the context of specific illustrative configurations. Other forms of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first layer could be termed a second layer, and, similarly, a second layer could be termed a first layer, without departing from the scope of the present disclosure. The first layer and the layer are both layers, but they are not the same layer.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description included example systems, methods, techniques, instruction sequences, and computing machine program products that embody illustrative implementations. For purposes of explanation, numerous specific details are set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for the purpose of explanation, has been described with reference to specific implementations. However, the illustrative discussions below are not intended to be exhaustive or to limit the implementations to the precise forms disclosed.

Many modifications and variations are possible in view of the above teachings. The implementations are chosen and described in order to best explain the principles and their practical applications, to thereby enable others skilled in the art to best utilize the implementations and various implementations with various modifications as are suited to the particular use contemplated.

In the interest of clarity, not all of the routine features of the implementations described herein are shown and described. It will be appreciated that, in the development of any such actual implementation, numerous implementation-specific decisions are made in order to achieve the designer's specific goals, such as compliance with use case constraints, and that these specific goals will vary from one implementation to another and from one designer to another. Moreover, it will be appreciated that such a design effort might be complex and time-consuming, but nevertheless be a routine undertaking of engineering for those of ordinary skill in the art having the benefit of the present disclosure.

For convenience in explanation and accurate definition in the appended claims, the terms “upper,” “lower,” “up,” “down,” “upwards,” “downwards,” “laterally,” “longitudinally,” “inner,” “outer,” “inside,” “outside,” “inwardly,” “outwardly,” “interior,” “exterior,” “front,” “rear,” “back,” “forwards,” and “backwards” are used to describe features of the exemplary embodiments with reference to the positions of such features as displayed in the figures.

Furthermore, when a reference number is given an “ith” denotation, the reference number refers to a generic component, set, or embodiment. For instance, a circuit component “circuit component i” refers to the ith circuit component in a plurality of circuit components (e.g., a circuit component 200-i in a plurality of circuit components 200).

As used herein, the term “deformable substrate” refers to a substrate or a portion of it (e.g., a layer) capable of altering its shape subject to pressure or stress.

Moreover, as used herein, the term “% porosity” or “percent porosity” means a percent of the total volume of a material that includes one or more voids (e.g., interconnected voids) or cavities of the material.

As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within one or more than one standard deviation, per the practice in the art. “About” can mean a range of ±20%, ±10%, ±5%, or ±1% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.

The term “% by weight,” “% wt,” “wt %,” or “w %” as used herein and referring to components of a coating, a layer, a material, or a solution is a percentage of the total weight of the coating, the layer, the material, or the solution, unless otherwise specified herein.

Moreover, the term “polymer” as used herein is defined as any macromolecule or system of macromolecules commonly referred to as “polymeric” and includes without limitation naturally occurring and synthetically produced macromolecules and repeating and non-repeating chain macromolecules. Polymers may optionally include one or more modifiers, fillers, filler compatibilizers, modifiers, impact modifiers, wetting and slip agents, UV enhancers, etc.

The term “polymeric material” as used herein is defined as one or more polymer(s) or other materials comprising or containing polymer(s), including, without limitation, blends of polymers, co-polymers, hybrid materials comprising bonded polymers and non-polymeric materials, and/or composites of or including any of the foregoing. The term “polymeric material” may also include a polymer containing one or more powdered organic material(s).

Furthermore, when a reference number is given an “ith” denotation, the reference number refers to a generic component, set, or embodiment. For instance, a compound termed “compound i” refers to the ith compound in a plurality of compounds.

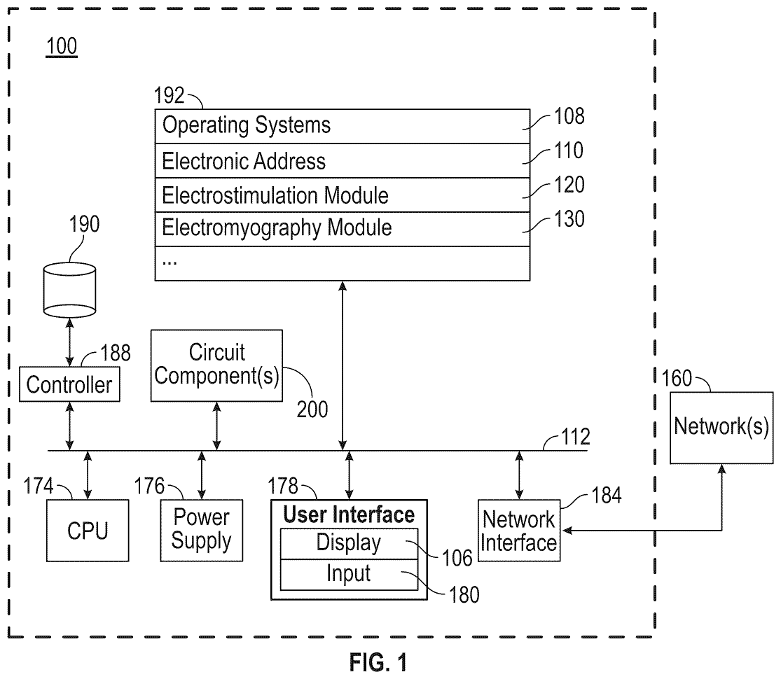

In the present disclosure, unless expressly stated otherwise, descriptions of devices and systems will include implementations of one or more optical devices. For instance, and for purposes of illustration in FIG. 1, an optical device 100 is represented as a single device that includes all the functionality of the optical device 100. However, the present disclosure is not limited thereto. For instance, the functionality of the optical device 100 may be spread across any number of networked computers and/or reside on each of several networked computers and/or hosted on one or more virtual machines and/or containers at a remote location accessible across a communications network (e.g., networks 160). One skilled in the art of the present disclosure will appreciate that a wide array of different computer topologies is possible for the optical device 100, and other devices and systems of the preset disclosure, and that all such topologies are within the scope of the present disclosure. As such, the exemplary topology shown in FIG. 1 merely serves to describe the features of an embodiment of the present disclosure in a manner that will be readily understood to one skilled in the art.

Referring to FIGS. 1 through 10, an exemplary optical device is provided. More specifically, FIG. 1 depicts a block diagram of an optical device (e.g., optical device 100) according to some embodiments of the present disclosure.

In some embodiments, the communication networks 160 optionally includes the Internet, one or more local area networks (LANs), one or more wide area networks (WANs), other types of networks, or a combination of such networks.

Examples of communication networks 160 include the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including Global System for Mobile Communications (GSM), Enhanced Data GSM Environment (EDGE), High-Speed Downlink Packet Access (HSDPA), High-Speed Uplink Packet Access (HSUPA), Evolution, Data-Only (EV-DO), HSPA, HSPA+, Dual-Cell HSPA (DC-HSPDA), long-term evolution (LTE), near-field communication (NFC), Wideband Code Division Multiple Access (WCDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), Voice over Internet Protocol (VOIP), WiMAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

In various embodiments, the optical device 100 includes one or more processing units (CPUs) 174, a network or other communications interface 184, and a memory 192.

The memory 192 includes high-speed random-access memory, such as DRAM, SRAM, DDR RAM, or other random-access solid-state memory devices, and optionally also includes non-volatile memory, such as one or more magnetic disk storage devices, optical disk storage devices, flash memory devices, or other non-volatile solid state storage devices. The memory 192 may optionally include one or more storage devices remotely located from the CPU(s) 174. The memory 192, or alternatively the non-volatile memory device(s) within memory 192, includes a non-transitory computer readable storage medium. Access to memory 192 by other components of the optical device 100, such as the CPU(s) 174, is, optionally, controlled by a controller. In some embodiments, the memory 192 can include mass storage that is remotely located with respect to the CPU(s) 174. In other words, some data stored in the memory 192 may in fact be hosted on devices that are external to the optical device 100, but that can be electronically accessed by the optical device 100 over an Internet, intranet, or other form of communication network 160 or electronic cable using communication interface 184.

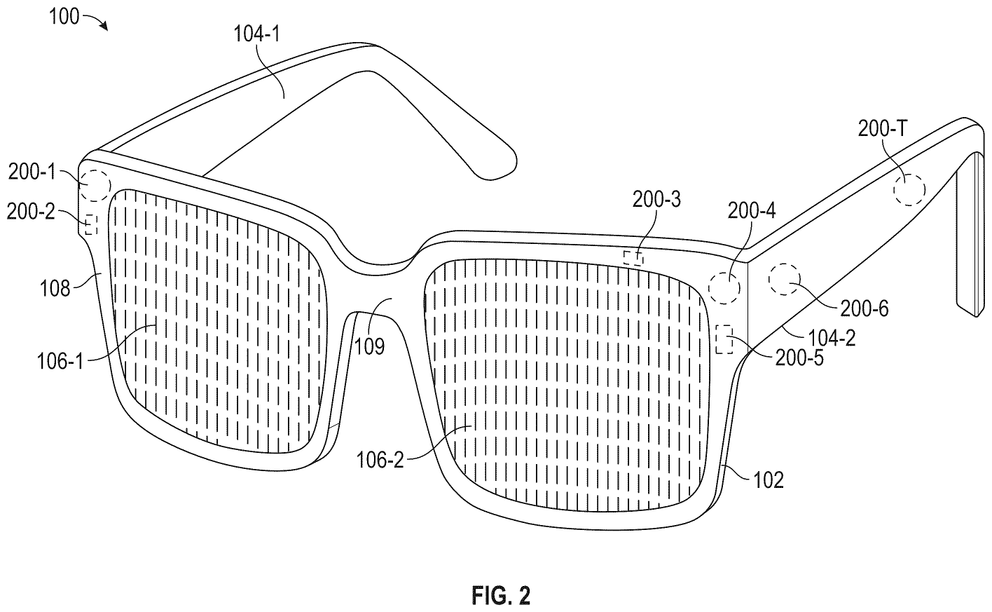

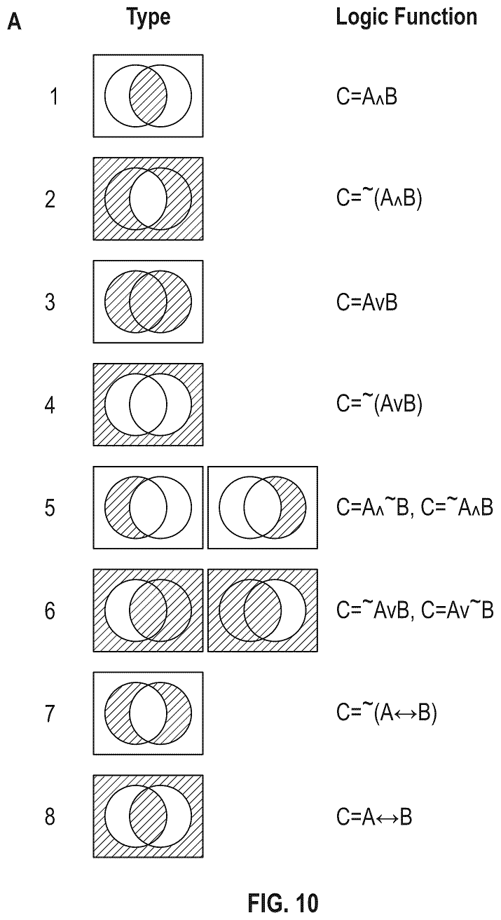

In some embodiments, the memory 192 of the optical device 100 stores an optional operating system 108 (e.g., ANDROID, IOS, DARWIN, RTXC, LINUX, UNIX, OS X, WINDOWS, or an embedded operating system such as VxWorks) that includes procedures for handling various basic system services; an electronic address 110 associated with the optical device 100 that identifies the optical device 100; optionally, an electrostimulation module 120 that stores one or more logic functions (e.g., one or more logic functions of FIG. 10) for generating and/or communicating one or more electronic signals to one or more circuit components (e.g., circuit component 200-1 of FIG. 2, circuit component 200-2 of FIG. 2, circuit component 200-3 of FIG. 2, circuit component 200-T of FIG. 2, etc.); and optionally, an electromyography module 130 that stores one or more logic functions (e.g., one or more logic functions of FIG. 10) for evaluation of one or more electronic signals received from the one or more circuit components (e.g., circuit component 200-1 of FIG. 2, circuit component 200-2 of FIG. 2, circuit component 200-3 of FIG. 2, circuit component 200-T of FIG. 2, etc.).

In some embodiments, an electronic address 110 is associated with the optical device 100. The electronic address 110 is utilized to identify the optical device 100 at least uniquely from other devices and components, such as though communicated through the communications network 160.

Each of the above-identified modules and applications correspond to a set of executable instructions for performing one or more functions described above and the methods described in the present disclosure (e.g., the computer-implemented methods and other information processing methods described herein, etc.). These modules (e.g., sets of instructions) need not be implemented as separate software programs, procedures or modules, and thus various subsets of these modules are, optionally, combined or otherwise re-arranged in various embodiments of the present disclosure. In some embodiments, the memory 192 optionally stores a subset of the modules and data structures identified above. Furthermore, in some embodiments, the memory 192 stores additional modules and data structures not described above.

It should be appreciated that the optical device 100 of FIG. 1 is only one example of an optical device 100, and that optical device 100 optionally has more or fewer components than shown, optionally combines two or more components, or optionally has a different configuration or arrangement of the components. The various components shown in FIG. 1 are implemented in hardware, software, firmware, or a combination thereof, including one or more signal processing and/or application-specific integrated circuits.

For instance, referring briefly to FIGS. 2-5D, in some embodiments, the optical device 100 is a garment that is worn by a subject, such as around a wrist, hand, finger, neck, waist, ankle or combination thereof of the subject. However, the present disclosure is not limited thereto. For instance, in some embodiments, the optical device 100 is a garment accessory, such as a pair of glasses (e.g., smart glasses), a pair of googles, a helmet, or a wristwatch (e.g., smart watch), worn by the subject.

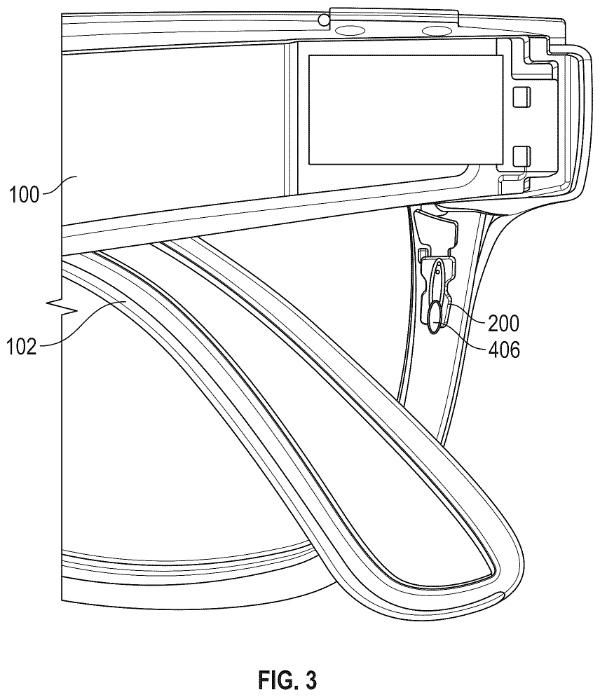

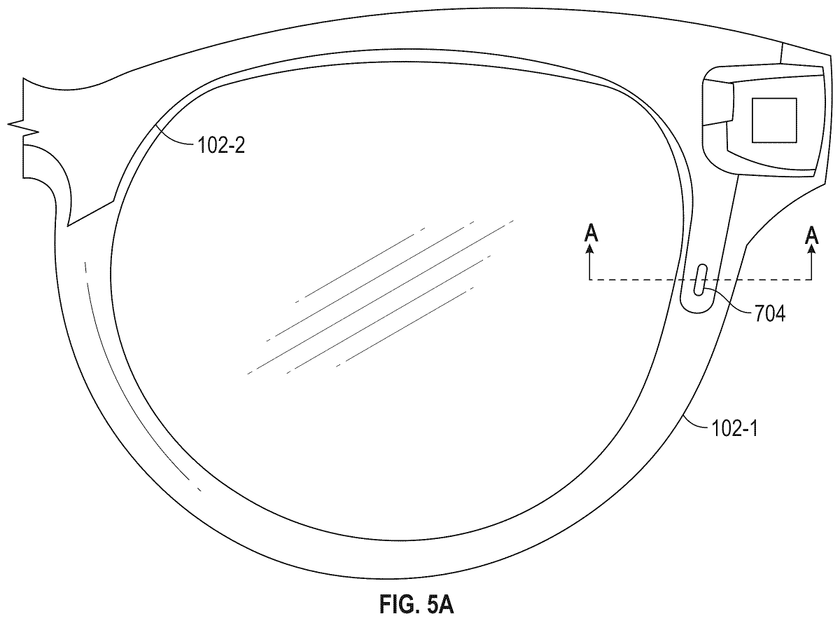

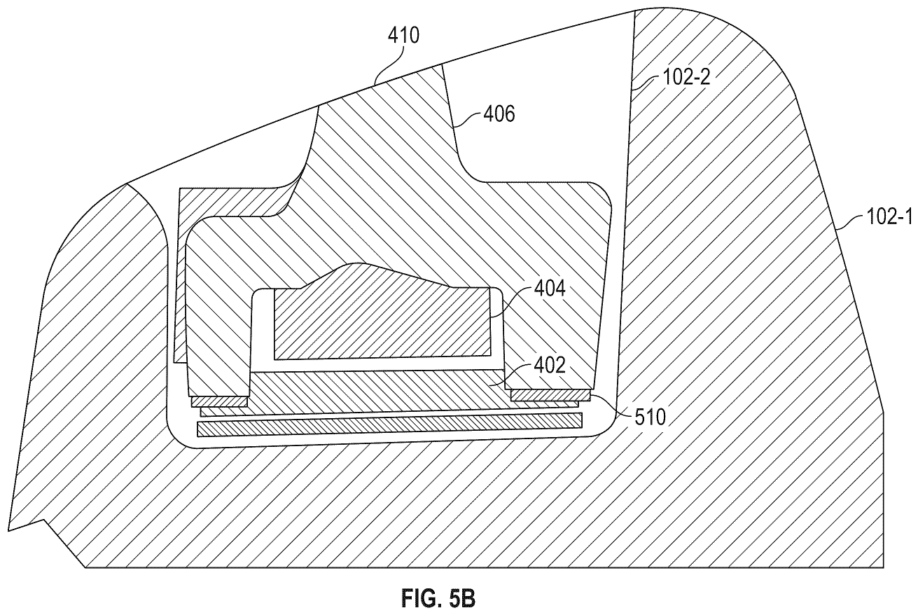

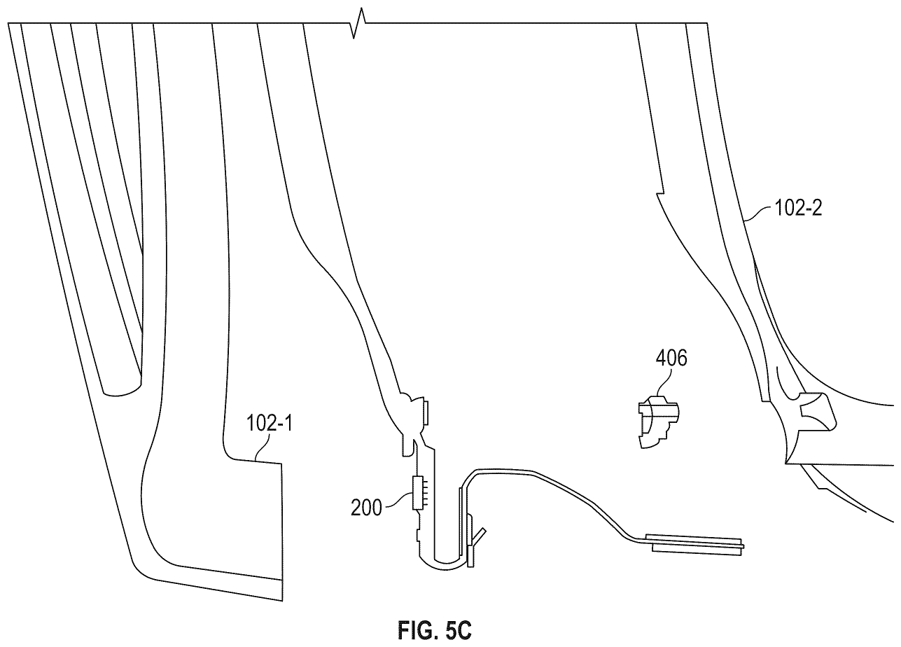

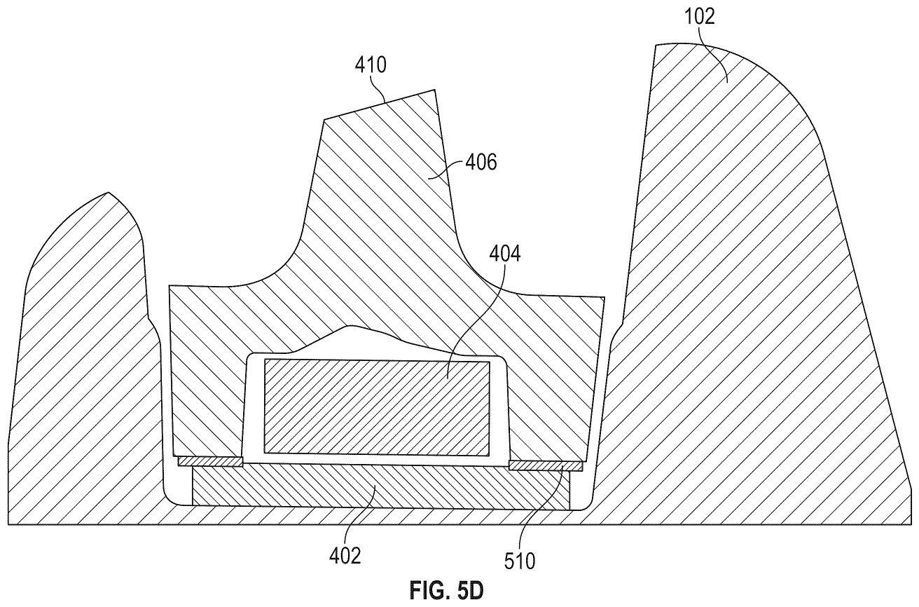

Accordingly, the optical device 100 includes a frame (e.g., frame 102 of FIG. 2, frame 102 of FIG. 3, frame 102 of FIG. 5A, frame 102-1 of FIG. 5B, frame portion 102-2 of FIG. 5, etc.), which allows the wearer of the optical device 100 to adorn the optical device 100 during a variety of activities. For instance, referring to FIG. 2, the optical device 100 includes a frame 102 including a rim, a bridge 109, and a pair of temples 104. However, the present disclosure is not limited thereto. In some embodiments, the frame 102 includes a plurality of frame portions, such as a first frame portion 102-1 and/or a second frame portion 102-2 of FIG. 5B. In some embodiments, the first frame portion 102-1 and the second frame portion 102-2 couple together through a fastener, such as a push fastener or pin fastener, which allows for forming one or more channels, one or more grooves, one or more cavities, or the like disposed interposing between the first frame portion 102-1 and the second frame portion 102-2. Moreover, in some such embodiments, the frame 102 is configured to accommodate one or more circuits, which allows for the optical device 100 to perform a variety of computational functions when being worn by the wearer. For instance, in some embodiments, the frame 102 includes one or more openings or apertures (e.g., aperture 704 of FIG. 5A) that is configured to expose an exterior surface of an object to an environment.

In some embodiments, the optical device 100 includes a circuit that further includes two or more circuit components 200 accommodated by the frame 102. In some embodiments, the circuit includes a printed circuit board (PCB). For instance, in some embodiments, the circuit includes one or more flexible printed circuits (FPCs). By utilizing the FPC with the circuit, the electronic device 100 of the present disclosure is provided with improved durability since substantially all of the electronic device 100 is formed of or on a deformable material. For instance, in some embodiments, a circuit component 200 of a circuit of the optical device 100 includes a terminal, an energy source (e.g., power supply 176 of FIG. 1), an interconnect (e.g., a line interconnect, such as a wire), a load (e.g., a device such as display 182 of FIG. 1, a light source 504, etc.), a controller (e.g., switch, CPU 174 of FIG. 1), or a combination thereof. As a non-limiting example, in some embodiments, the circuit component 200 includes a terminal, a resistor, a transistor, a capacitor, an inductor, a transformer, a diode, a sensor, a light source or combination thereof. In some embodiments, the first circuit component 200-1 is the same type of component as the second circuit component 200-1 (e.g., both the first circuit component 200-1 and the second circuit component 200-2 include a light source, both the first circuit component 200-1 and the second circuit component 200-2 include a light source configured to emit light from the visible spectrum, etc.). However, the present disclosure is not limited thereto.

In some embodiments, the first circuit component 200-1 and the second circuit component 200-2 are part of a transistor switch. For instance, in some embodiments, the transistor switch is configured to control an electronical communication through the optical device 100 using a logic function, such as an OR logic function based on either a cutoff or saturation of the electronical communication. In some embodiments, two or more transistor switches are arranged (e.g., in series and/or parallel) in order to implement a logic function, such as one or more logic functions of FIG. 10. For instance, in some embodiments, a first state of the first circuit component 200-1 (e.g., an ON state, an OFF state, a first state associated with a first wavelength of light, a second state associated with a second wavelength of light, etc.) and/or a second state of the second circuit components 200-2 are used to display an interpretation or output of the logic functions of FIG. 10. However, the present disclosure is not limited thereto.

In some embodiments, the circuit components 200 are disposed at one or more specific positions of the optical device 100 relative to one another and relative to a specific reference point on the optical device. In some embodiments, the circuit components 200 are located beneath an exterior surface of the optical device, such as disposed interposing between two or more layers of the semi-transparent frame 102 of the optical device 100. Accordingly, the optical device 100 of the present disclosure is capable of incorporating a variety of numbers of circuit components 200, which allows providing optical devices 100 of high complexity, such as wearable garment optical devices 100, with substrates 402 that permit continuous electronic communication between two or more circuit components 200 of the optical device 100 when the optical device 100 is physically deformed, or the like.

In some embodiments, as shown in FIG. 2, the optical device 100 includes display device 700, which includes a frame 102 and one or more lens or displays 106, hereinafter “display.”

In some embodiments, the display 106 is a lens, such as a first lens including a glass material, a silicon material, a polymeric material, or a combination thereof, which allows for the wearer to use the optical device 100 as eyewear, such as prescription eyewear, during everyday activities. In some embodiments, the display 106 is configured for presenting visual contents (e.g., augmented reality contents, virtual reality contents, mixed reality contents, or any combination thereof) to a user, such as the wearer or an observer viewing the wearer.

In some embodiments, the display 106 of the optical device 100 is configured as an augmented reality (AR) headset. In some embodiments, the display 106 of the optical device 100 is configured to augment views of a physical, real-world environment with computer-generated elements (e.g., images, video, sound, etc.). Moreover, in some embodiments, the display 106 of the optical device 100 is configured to be able to cycle between different types of operation. Thus, in some embodiments, the display 106 of the optical device 100 is configured to operate as a mixed-reality (MR) device capable of providing a fully virtual reality (VR) experience, an augmented reality (AR) device, such as smart glasses or some combination thereof (e.g., glasses with no optical correction, glasses optically corrected for the user, sunglasses, or some combination thereof) based on instructions from the application engine. In some embodiments, the device may not include a display and only include the light guide described herein.

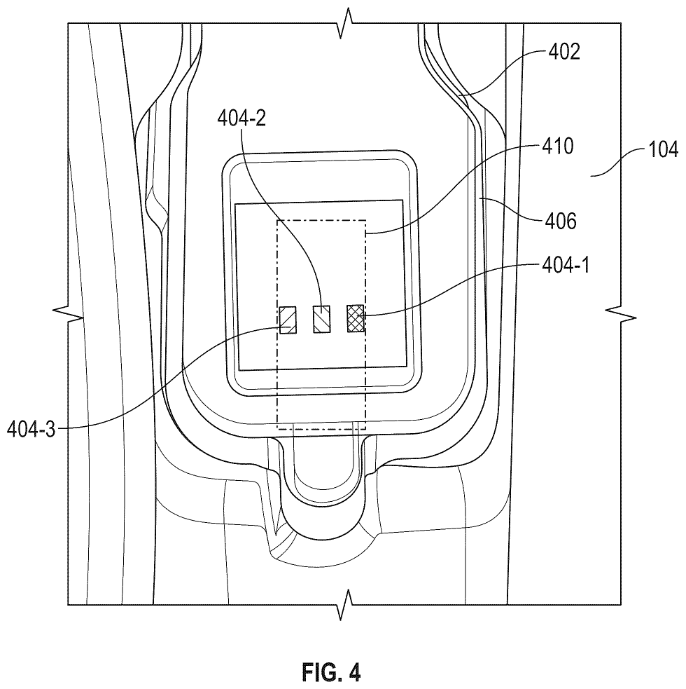

In some embodiments, the circuit component 200 of the optical device 100 includes one or more light sources (e.g., first light source 404-1 of FIG. 4, second light source 404-2 of FIG. 4, . . . , light source R 404-R of FIG. 4, etc.). For instance, in some embodiments, the frame 102 is configured to accommodate the one or more light sources 404, such that the one or more light sources 404 is in electronic communication with the processor 174 of the optical device 100, the controller 188 of the optical device 100, and/or the power supply 176 of the optical device 100 when the optical device 100 is worn by the wearer.

In some embodiments, a light source 404 in the one or more light sources 404 includes a light emitted diode (LED), such as a red LED, a blue LED, and/or a green LED. Thus, in some embodiments, a first light source 404-1 emits a first spectral range or wavelength, a second light source 404-2 emits a second spectral range or wavelength, a third light source 404-3 emits a third spectral range or wavelength, and a fourth light source 404-4 emits a fourth spectral range or wavelength. For example, the first light source 404-1 can emit red light, the second light source 404-2 can emit blue light, the third light source 404-3 can emit green light, and the fourth light source set 404-4 can emit infrared light. However, the present invention is not limited thereto. In some embodiments, various light sources 404 in the one or more light source 404 share or overlap within a spectral range.

In some embodiments, the light source 404 includes one or more stable LEDs, one or more tunable LEDs, or a combination thereof. In some embodiments, the light source 404 has a predetermined spectral range or wavelength. In some embodiments, the light source 404 varies in wavelength with time or a predetermined function. In some embodiments, the light source 404 includes a corresponding array of spatial light modulators. In some embodiments, the corresponding array of spatial light modulators is an array of electro-optic pixels, opto-electronic pixels, some other array of devices that dynamically adjusts the amount of light transmitted by each device, or some combination thereof. In some embodiments, the spatial light modulator is an array of liquid crystal-based pixels in an LCD (a Liquid Crystal Display). Non-limiting examples of the light source includes an organic LED, an active matrix organic LED, an LED, some type of device capable of being placed in a flexible display, or some combination thereof. In some embodiments, the light source 404 includes one or more broadband sources (e.g., one or more white LEDs) coupled with a plurality of color filters, in addition to, or instead of, the light source 404.

In some embodiments, the one or more light sources 404 includes a non-polarized light source 404, a polarized light source 404, or a combination thereof. In some embodiments, the polarized light source 404 includes a linear polarized source 404, a cross-polarized source 404, a circular polarized source 404, or a combination thereof.

In some embodiments, emitted light by the light source 404 has a radiant flux between 5 milliwatts (mW) and 95 mW. In some embodiments, emitted light by the light source 404 has a radiant flux between 10 mW and 75 mW. In some embodiments, emitted light by the light source 404 has a radiant flux between 1 mW and 100 mW. In some embodiments, emitted light by the light source 404 has a radiant flux between 50 mW and 1000 mW. In some embodiments, emitted light by the light source 404 has a radiant flux between 0.01 mW and 100 mW.

In some embodiments, the optical device 100 includes a light guide (e.g., light guide 406 of FIG. 3, light guide 406 of FIG. 5B, light guide 406 of FIG. 5D, etc.) that is coupled, at least in part, to the light source 404. For instance, in some embodiments, an exterior surface 410 of the light guide 406 is configured to be accommodated, at least in part, by an aperture 704 of the frame 102, which allows for light to be emitted through the light guide 406 external to the frame 102. In some embodiments, the exterior surface 410 of the light guide 406 is flush with a surface of the frame 102. The term “flush,” as used herein, is defined as a surface of a first component and a same respective surface of a second component to have a distance or level separating the first component and the second component to be 0.0 cm, within a tolerance of 50 μm, within a tolerance of 0.1 mm, within a tolerance of 0.1 cm, or within a tolerance of 0.25 cm. In some embodiments, the same respective surface of the second component is coplanar to the surface of the first component. In some embodiments, the exterior surface 410 of the light guide 406 is considered to be flush with a second surface of the frame 102 if the exterior surface 410 of the light guide 406 is internally disposed within the frame 102 or integrated with the frame 102. However, the present disclosure is not limited thereto.

In some embodiments, the light guide 406 is of the same circuit component 200 of the light source 404, which allows for easily repairing or controlling features of the light emitted by the light source 404. However, the present disclosure is not limited thereto. In some embodiments, the light guide 406 is configured to direct and/or distribute light emitted from the light source 404 to a surface of the optical device 100, such as an external surface of the semi-transparent frame 102 housing the circuit component 200 or an external surface of the light guide 406 itself. However, the present disclosure is not limited thereto. For instance, in some embodiments, the light guide 406 is configured to direct light from the light source 404 to one or more locations within the peripheral vision and/or focus of the wearer of the optical device 100. In some such embodiments, the light guide 406 emits light on a surface that faces a user's face when the optical device 100 is donned by the user, which allows for the user to capture light emitted by the light source 404 through the user's retina. However, the present disclosure is not limited thereto.

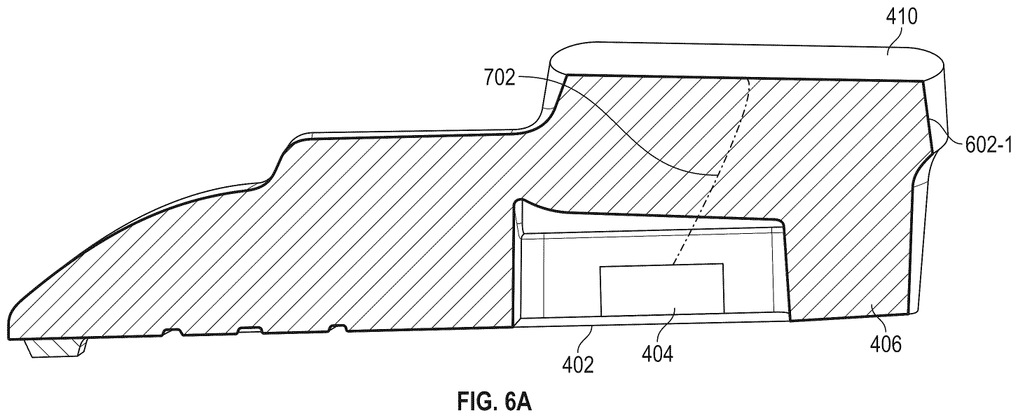

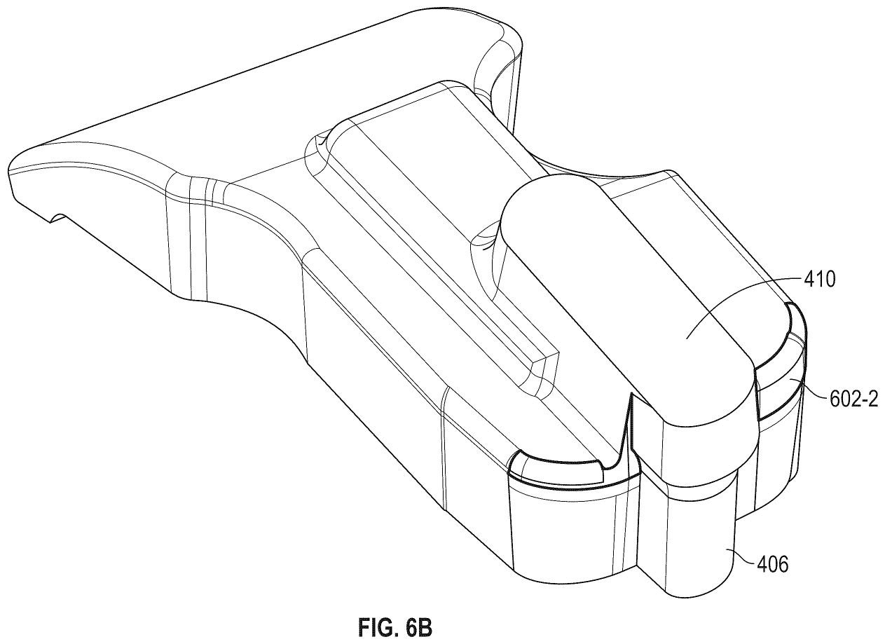

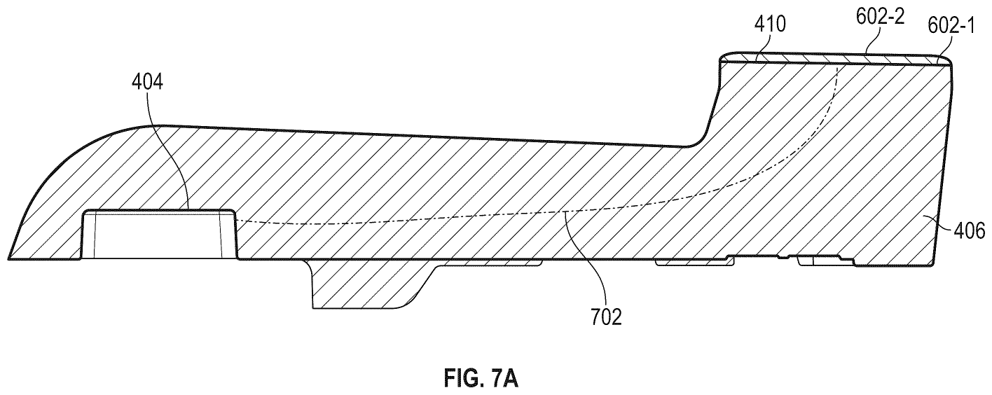

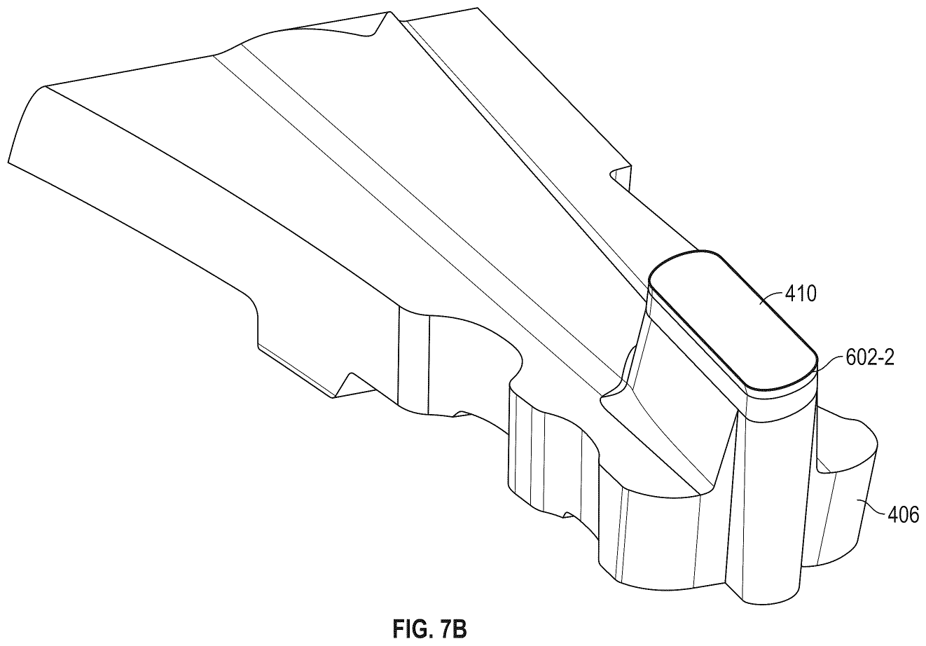

Referring briefly to FIGS. 6A-7B, in some embodiments, the light guide 406 is a three-dimensional structure configured to guide light emitted by the light source 404 to an external surface of the light guide 406 via an optical path 702 internal to the light guide 406. In some such embodiments, the light guide 406 is a monolithic structure, which aids in reflecting light through the optical path 702 of the light guide 406 without leaking to an environment, such as the peripheral vision of the wearer. For instance, in some embodiments, the light guide 406 is a solid structure that uses internal reflection to guide light emitted by the light source 404 through the optical path 702 extending from a first end portion of the light guide 406 to a second end portion of the light guide 406, such as from a first end portion of the frame 102 to a second end portion of the frame 102 that is proximate to the eye of the wearer than the first end portion of the frame 102. Moreover, in some embodiments, the optical path 702 of the light guide 406 includes a channel or cavity that includes a reflective interior surface, which allows for transmitting light through the channel or cavity to the second end portion of the frame 102 and/or the light guide 406. Furthermore, in some embodiments, the exterior surface 410 of the light guide 406 is parallel or substantially parallel with the optical path 702 of the light guide 406 and/or a surface of the frame 102, such that the light guide 406 forms a portion of an exterior of the optical device 100. However, the present disclosure is not limited thereto. Accordingly, the light guide 406 allows for disposing the light source 404 at a location remote from where the light is emitted at an observable angle to the wearer of the optical device 100.

In some embodiments, the light guide 406 includes the optical path 702 extending from a first end portion of the light source 404 to the exterior surface 410 of the light guide 406, allowing for light to pass and be internally reflected by the light guide 406 before emittance from the exterior surface 410. In some embodiments, the optical path 702 is configured to blend or mix light emitted from a plurality of light sources 404. For instance, referring briefly to FIG. 4, in some embodiments, the light guide 406 is configured to combine blue light emitted from the first light source 404-1 and red light emitted from the third light source 404-3 in order to emit purple light that is viewable by the wearer or an observer of the optical device 100. As a non-limiting example, longer lengths for the optical path 702 in some embodiments causes increased mixing of light emitted by the plurality of light sources 404. In some embodiments, the light guide 406 is configured to produce coherent rays or beams of light or to reduce mixing of light emitted from the plurality of light sources. However, the present disclosure is not limited thereto.

In some embodiments, the length of the optical path 702 is between 1 mm and 10 cm, between 1 mm and 7.5 cm, between 1 mm and 5 cm, between 1 mm and 1 cm, between 5 mm and 10 cm, between 5 mm and 7.5 cm, between 5 mm and 5 cm, between 5 mm and 1 cm, between 1 cm and 10 cm, between 1 cm and 7.5 cm, between 1 cm and 5 cm, or between 1 cm and 10 cm. In some embodiments, the length of optical path 702 is at least 1 mm, at least 5 mm, at least 10 mm, at least 5 cm, or at least 10 cm. In some embodiments, the length of the channel 210 is at most 1 mm, at most 5 mm, at most 10 mm, at most 5 cm, or at most 10 cm. For instance, in some embodiments, the length of the optical path 702 is configured to extend between a thickness of the frame 102, a length of the frame 102, or the like, such as between a distal end portion of the frame 102 and a proximal portion of the frame 102. However, the present disclosure is not limited thereto.

In some embodiments, the light guide 406 has a first transmittance curve and the frame 102 of the optical device 100 has a second transmittance curve different from the first transmittance curve, which allows for light to transmit through the light guide 406 but not the frame 102. However, the present disclosure is not limited thereto. In some embodiments, the light guide 406 is configured to provide one or more surfaces 410 that has a uniform transmittance across the surface 410, allowing for light to transmit through the surface 410.

In some embodiments, the light guide 406 includes a nylon material. For instance, in some embodiments, the light guide 406 is made of a material including nylon or polyamide (PA), polycarbonate (PC), polypropylene, polysulfone, polyethylene or any combination thereof. As a non-limiting example, in some embodiments, the light guide 406 includes a monofilament nylon or a polyfilament nylon.

In some embodiments, a dimension of the exterior surface 410 of the light guide 406 is between 0.35 mm and 3.5 mm. For instance, in some embodiments, the dimension of the exterior surface 410 is between 0.35 mm and 3.5 mm, 0.35 mm and 2 mm, 0.5 mm and 3.5 mm, 0.5 mm and 2 mm, 0.65 mm and 3.5 mm, 0.65 mm and 2 mm, 0.7 mm and 3.5 mm, 0.7 mm and 2 mm, 1 mm and 3.5 mm, 1 mm and 2 mm, 1.3 mm and 3.5 mm, 1.3 mm and 2 mm, 1.5 mm and 3.5 mm, 1.5 mm and 2 mm, 1.7 mm and 3.5 mm, 1.7 mm and 2 mm, 2 mm and 3.5 mm, 2.3 mm and 3.5 mm, 2.5 mm and 3.5 mm, 2.7 mm and 3.5 mm, 3 mm and 3.5 mm, or 3.3 mm and 3.5 mm. In some embodiments, the dimension of the exterior surface 410 of the light guide 406 is at least 0.35 mm, at least 0.5 mm, at least 0.65 mm, at least 0.7 mm, at least 1 mm, at least 1.3 mm, at least 1.5 mm, at least 1.7 mm, at least 2 mm, at least 2.3 mm, at least 2.5 mm, at least 2.7 mm, at least 3 mm, at least 3.3 mm, or at least 3.5 mm. In some embodiments, the dimension of the exterior surface 410 of the light guide 406 is at most 0.35 mm, at most 0.5 mm, at most 0.65 mm, at most 0.7 mm, at most 1 mm, at most 1.3 mm, at most 1.5 mm, at most 1.7 mm, at most 2 mm, at most 2.3 mm, at most 2.5 mm, at most 2.7 mm, at most 3 mm, at most 3.3 mm, or at most 3.5 mm.

In some embodiments, a surface area of the exterior surface 410 of the light guide 406 is between 0.35 mm and 3.5 mm. For instance, in some embodiments, the surface of the exterior surface 410 is between 0.35 mm and 3.5 mm, 0.35 mm and 2 mm, 0.5 mm and 3.5 mm, 0.5 mm and 2 mm, 0.65 mm and 3.5 mm, 0.65 mm and 2 mm, 0.7 mm and 3.5 mm, 0.7 mm and 2 mm, 1 mm and 3.5 mm, 1 mm and 2 mm, 1.3 mm and 3.5 mm, 1.3 mm and 2 mm, 1.5 mm and 3.5 mm, 1.5 mm and 2 mm, 1.7 mm and 3.5 mm, 1.7 mm and 2 mm, 2 mm and 3.5 mm, 2.3 mm and 3.5 mm, 2.5 mm and 3.5 mm, 2.7 mm and 3.5 mm, 3 mm and 3.5 mm, or 3.3 mm and 3.5 mm. In some embodiments, the surface area of the exterior surface 410 of the light guide 406 is at least 0.35 mm, at least 0.5 mm, at least 0.65 mm, at least 0.7 mm, at least 1 mm, at least 1.3 mm, at least 1.5 mm, at least 1.7 mm, at least 2 mm, at least 2.3 mm, at least 2.5 mm, at least 2.7 mm, at least 3 mm, at least 3.3 mm, or at least 3.5 mm. In some embodiments, the surface area of the exterior surface 410 of the light guide 406 is at most 0.35 mm, at most 0.5 mm, at most 0.65 mm, at most 0.7 mm, at most 1 mm, at most 1.3 mm, at most 1.5 mm, at most 1.7 mm, at most 2 mm, at most 2.3 mm, at most 2.5 mm, at most 2.7 mm, at most 3 mm, at most 3.3 mm, or at most 3.5 mm.

In some embodiments, the light source 404 includes a substrate 402 that is configured to, at least in part, couple the light source 404 to the frame 102 and/or the circuit component 200. In some embodiments, the substrate 402 includes a supporting material upon which or within which an object (e.g., light source 404 and/or light guide 406) is disposed to or attached to or is on. Moreover, in some embodiments, the substrate 402 is configured to block some or all of the light emitted by the light source 404 opposite the light guide 406. For instance, in some embodiments, the substrate 402 is configured to seal the light source 404 within a cavity or opening formed by the frame 102 and/or the light guide 406 in order to prevent light leakage from the light source 404. Accordingly, in some embodiments, the substrate 402 is configured to reflect light back towards the light guide 406 for improved illuminance through the exterior surface 410 of the light guide 406. For instance, in some embodiments, the substrate 402 includes a black or opaque material (e.g., a black coverlay layer of the circuit component 200), which limits light transmission through the substrate 402. However, the present disclosure is not limited thereto. In some embodiments, the substrate 402 includes a polyimide material, such as a polyimide-clad laminate. In some embodiments, the substrate 402 includes polyethylene, PEEK, polyester, aramid, composite, glass epoxy, polyethylene naphalate, polyimide, or a combination thereof.

In some embodiments, the substrate 402 is rigid or flexible, stretchable or non-stretchable, thick or thin (e.g., in the form of a sheet or a film), removable (e.g., the substrate 402 functions as a sacrificial layer that can be at least partially removed when desired or needed) or non-removable, or any combination thereof.

In some embodiments, the reflectance of the substrate 402 is between 50% and 100%, 50% and 75%, 52% and 98%, 52% and 73%, 53% and 97%, 53% and 72%, 55% and 95%, 55% and 70%, 56% and 94%, 56% and 69%, 58% and 92%, 58% and 67%, 60% and 90%, 60% and 65%, 61% and 89%, 61% and 64%, 63% and 87%, 65% and 85%, 66% and 84%, 68% and 82%, 69% and 81%, 71% and 79%, 73% and 77%, 74% and 76%, 75% and 100%, 77% and 98%, 78% and 97%, 80% and 95%, 81% and 94%, 83% and 92%, 85% and 90%, or 86% and 89%. In some embodiments, the reflectance of the substrate 402 is at least 50%, at least 52%, at least 53%, at least 55%, at least 56%, at least 58%, at least 60%, at least 61%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 89%, at least 90%, at least 92%, at least 94%, at least 95%, at least 97%, at least 98%, at least 99%, or at least 100%. In some embodiments, the reflectance of the substrate 402 is at most 50%, at most 52%, at most 53%, at most 55%, at most 56%, at most 58%, at most 60%, at most 61%, at most 63%, at most 64%, at most 65%, at most 66%, at most 67%, at most 68%, at most 69%, at most 70%, at most 71%, at most 72%, at most 73%, at most 74%, at most 75%, at most 76%, at most 77%, at most 78%, at most 79%, at most 80%, at most 81%, at most 82%, at most 83%, at most 84%, at most 85%, at most 86%, at most 87%, at most 89%, at most 90%, at most 92%, at most 94%, at most 95%, at most 97%, at most 98%, at most 99%, or at most 100%.

In some embodiments, the substrate 402 includes a material with an absorbance coefficient between 0.0001 and 0.5 per cm, between 0.0001 and 0.2 per cm, between 0.0001 and 0.1 per cm, between 0.001 and 0.5 per cm, between 0.001 and 0.2 per cm, between 0.001 and 0.1 per cm, between 0.01 and 0.5 per cm, between 0.01 and 0.2 per cm, between 0.01 and 0.1 per cm, between 0.1 and 0.5 per cm, or between 0.1 and 0.2 per cm. In some embodiments, the absorbance coefficient of the substrate 402 is at least 0.0001 per cm, at least 0.0005 per cm, at least 0.001 per cm, at least 0.005 per cm, at least 0.01 per cm, at least 0.05 per cm, at least 0.1 per cm, or at least 0.2 per cm. In some embodiments, the absorbance coefficient of the substrate 402 is at most 0.0001 per cm, at most 0.0005 per cm, at most 0.001 per cm, at most 0.005 per cm, at most 0.01 per cm, at most 0.05 per cm, at most 0.1 per cm, or at most 0.2 per cm.

In some embodiments, the light guide 406 is separated by an adhesive layer (e.g., adhesive layer 510 of FIG. 5B, adhesive layer 510 of FIG. 5D, etc.) that couples the light source 404 to the circuit of the frame 102. Moreover, in some embodiments, the adhesive layer of the optical device 100 is configured to block and/or limit light leakage between the light guide 406 and the circuit and/or the frame 102 of the optical device 100. In some embodiments, the coating 602 is adhered to the light guide 406 in order to limit transmission of light through the coating 602, such that only the external surface 410 of the light guide 406 is illuminated. However, the present disclosure is not limited thereto. In some embodiments, the adhesive layer includes a pressure sensitive adhesive (PSA) material, which allows for the adhesive layer 510 to elastically deform, such as when a bending force is applied to the optical device 100.

In some embodiments, the adhesive layer 510 is rigid or flexible, stretchable or non-stretchable, thick or thin (e.g., in the form of a sheet or a film), removable (e.g., the adhesive layer 510 functions as a sacrificial layer that can be at least partially removed when desired or needed) or non-removable, or any combination thereof. For instance, in some embodiments, the adhesive layer 510 or at least a portion of the adhesive layer 510 is flexible, bendable, stretchable, inflatable, or the like. For instance, in some embodiments, the adhesive layer 510 or at least a portion of the adhesive layer 510 is made with a material having a Young's Modulus lower than about 0.5 Giga-Pascals (GPa), lower than about 0.4 GPa, lower than about 0.3 GPa, or lower than about 0.2 GPa. Such a material allows the adhesive layer 510 or a portion of the adhesive layer 510 to deform (e.g., bend, stretch, elongate, rotate, or the like) under pressure, strain, torsion, or a combination.

In some embodiments, the optical device 100 includes one or more coatings 602 that are configured to control one or more properties of light emitted and/or transmitted by and/or through the optical device 100. For instance, in some embodiments, the light guide 406 includes the one or more coatings 602, such as a first coating 602-1 disposed on an exterior surface of the light guide 406 and/or a second coating 602-2 disposed interposing between two intermediate layers of the light guide 406. However, the present disclosure is not limited thereto. In some embodiments, the one or more coatings 602 include a base coating, one or more intermediate coatings, an upper (e.g., top) coating, a primer coating, an indium coating, or a combination thereof. For instance, in some embodiments, the one or more coatings 602 include a first primer coating 602-1, a second base coating 602-2, a third indium coating 602-3, a fourth intermediate coating 602-4, and a fifth top coating 602-5. In some embodiments, the one or more coatings 602 include the first primer coating 602-1. In some embodiments, the one or more coatings include the first primer coating 602-1 and the fifth top coating 602-5. However, the present disclosure is not limited thereto.

In some embodiments, the one or more coatings 602 include between 2 coatings and 12 coatings, between 2 coatings and 8 coatings, between 2 coatings and 6 coatings, between 2 coatings and 4 coatings, between 4 coatings and 12 coatings, between 4 coatings and 8 coatings, between 4 coatings and 6 coatings, between 6 coatings and 12 coatings, between 6 coatings and 8 coatings, between 8 coatings and 12 coatings, or between 10 coatings and 12 coatings. In some embodiments, the one or more coatings 602 include at least 2 coatings, at least 3 coatings, at least 4 coatings, at least 5 coatings, at least 6 coatings, at least 8 coatings, at least 10 coatings, or at least 12 coatings. In some embodiments, the one or more coatings 602 include at most 2 coatings, at most 3 coatings, at most 4 coatings, at most 5 coatings, at most 6 coatings, at most 8 coatings, at most 10 coatings, or at most 12 coatings.

In some embodiments, the first coating 602-1 is an organic compound. In some embodiments, the organic compound is selected from a group consisting of a low volatile organic compound (LVOC) coating, a non-conductive vacuum metallizing (NCVM) coating, and organic water-based (WB) coating. In some embodiments, the first coating 602-1 is selected from a group consisting of a low volatile organic compound (LVOC) coating, a non-conductive vacuum metallizing (NCVM) coating, and organic WB coating. Accordingly, the first coating 602-1 utilizes a material with a high reflectance, such as a metallic luster or sheen, which allows for reflecting light internally through the light guide 406 emitted by the light source 404 that is not totally internally refracted by the material of the light guide 406 or emitted through the external surface 410 of the light guide 406. However, the present disclosure is not limited thereto.

In some embodiments, the reflectance of the first coating 602-1 is between 50% and 100%, 50% and 75%, 52% and 98%, 52% and 73%, 53% and 97%, 53% and 72%, 55% and 95%, 55% and 70%, 56% and 94%, 56% and 69%, 58% and 92%, 58% and 67%, 60% and 90%, 60% and 65%, 61% and 89%, 61% and 64%, 63% and 87%, 65% and 85%, 66% and 84%, 68% and 82%, 69% and 81%, 71% and 79%, 73% and 77%, 74% and 76%, 75% and 100%, 77% and 98%, 78% and 97%, 80% and 95%, 81% and 94%, 83% and 92%, 85% and 90%, or 86% and 89%. In some embodiments, the reflectance of the first coating 602-1 is at least 50%, at least 52%, at least 53%, at least 55%, at least 56%, at least 58%, at least 60%, at least 61%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 89%, at least 90%, at least 92%, at least 94%, at least 95%, at least 97%, at least 98%, at least 99%, or at least 100%. The weights range from at most 50%, at most 52%, at most 53%, at most 55%, at most 56%, at most 58%, at most 60%, at most 61%, at most 63%, at most 64%, at most 65%, at most 66%, at most 67%, at most 68%, at most 69%, at most 70%, at most 71%, at most 72%, at most 73%, at most 74%, at most 75%, at most 76%, at most 77%, at most 78%, at most 79%, at most 80%, at most 81%, at most 82%, at most 83%, at most 84%, at most 85%, at most 86%, at most 87%, at most 89%, at most 90%, at most 92%, at most 94%, at most 95%, at most 97%, at most 98%, at most 99%, or at most 100%.

In some embodiments, the first coating 602-1 includes a material with an absorbance coefficient between 0.0001 and 0.5 per cm, between 0.0001 and 0.2 per cm, between 0.0001 and 0.1 per cm, between 0.001 and 0.5 per cm, between 0.001 and 0.2 per cm, between 0.001 and 0.1 per cm, between 0.01 and 0.5 per cm, between 0.01 and 0.2 per cm, between 0.01 and 0.1 per cm, between 0.1 and 0.5 per cm, or between 0.1 and 0.2 per cm. In some embodiments, the absorbance coefficient of the first coating 602-1 is at least 0.0001 per cm, at least 0.0005 per cm, at least 0.001 per cm, at least 0.005 per cm, at least 0.01 per cm, at least 0.05 per cm, at least 0.1 per cm, or at least 0.2 per cm. In some embodiments, the absorbance coefficient of the first coating 602-1 is at most 0.0001 per cm, at most 0.0005 per cm, at most 0.001 per cm, at most 0.005 per cm, at most 0.01 per cm, at most 0.05 per cm, at most 0.1 per cm, or at most 0.2 per cm.

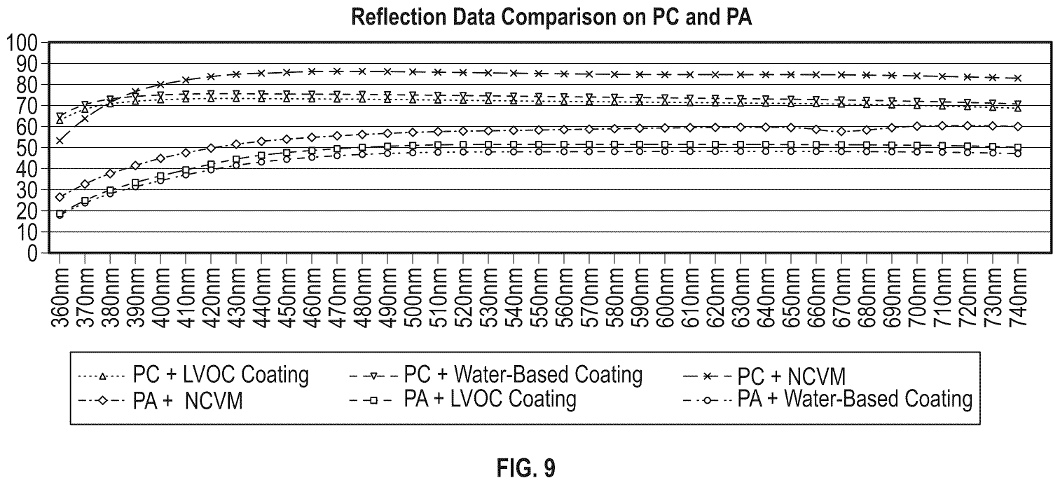

Referring briefly to FIG. 9, the reflectance of a variety of coatings 602 are provided in accordance with some embodiments of the present disclosure.

In some embodiments, the first coating 602-1 includes one or more LVOC materials. For instance, in some embodiments, the LVOC material includes a hydrocarbon. In some embodiments, the LVOC material includes a compound with a boiling point that is between 216° C. and 450° C., 216° C. and 333° C., 224° C. and 442° C., 224° C. and 325° C., 231° C. and 435° C., 231° C. and 318° C., 239° C. and 427° C., 239° C. and 310° C., 246° C. and 420° C., 246° C. and 303° C., 254° C. and 412° C., 254° C. and 295° C., 261° C. and 405° C., 261° C. and 288° C., 269° C. and 397° C., 269° C. and 280° C., 276° C. and 390° C., 284° C. and 382° C., 291° C. and 375° C., 299° C. and 367° C., 307° C. and 359° C., 314° C. and 352° C., 322° C. and 344° C., 329° C. and 337° C., 333° C. and 450° C., 341° C. and 442° C., 348° C. and 435° C., 356° C. and 427° C., 363° C. and 420° C., 371° C. and 412° C., 378° C. and 405° C., or 386° C. and 397° C. In some embodiments, the LVOC material includes a compound with a boiling point that is at least 216° C., at least 224° C., at least 231° C., at least 239° C., at least 246° C., at least 254° C., at least 261° C., at least 269° C., at least 276° C., at least 280° C., at least 284° C., at least 288° C., at least 291° C., at least 295° C., at least 299° C., at least 303° C., at least 307° C., at least 310° C., at least 314° C., at least 318° C., at least 322° C., at least 325° C., at least 329° C., at least 333° C., at least 337° C., at least 341° C., at least 344° C., at least 348° C., at least 352° C., at least 356° C., at least 359° C., at least 363° C., at least 367° C., at least 371° C., at least 375° C., at least 378° C., at least 382° C., at least 386° C., at least 390° C., at least 397° C., at least 405° C., at least 412° C., at least 420° C., at least 427° C., at least 435° C., at least 442° C., or at least 450° C. In some embodiments, the LVOC material includes a compound with a boiling point that is at most 216° C., at most 224° C., at most 231° C., at most 239° C., at most 246° C., at most 254° C., at most 261° C., at most 269° C., at most 276° C., at most 280° C., at most 284° C., at most 288° C., at most 291° C., at most 295° C., at most 299° C., at most 303° C., at most 307° C., at most 310° C., at most 314° C., at most 318° C., at most 322° C., at most 325° C., at most 329° C., at most 333° C., at most 337° C., at most 341° C., at most 344° C., at most 348° C., at most 352° C., at most 356° C., at most 359° C., at most 363° C., at most 367° C., at most 371° C., at most 375° C., at most 378° C., at most 382° C., at most 386° C., at most 390° C., at most 397° C., at most 405° C., at most 412° C., at most 420° C., at most 427° C., at most 435° C., at most 442° C., or at most 450° C.

For instance, in some embodiments, the LVOC includes a highly oxidized functional group, such as a hydroxyl or hydroperoxyl functional group. In some embodiments, the LVOC includes an alcohol. In some embodiments, the LVOC material of the first coating 602-1 includes 1,3-butadiene, acrylonitrile, benzene, isoprene, toluene, or a combination thereof.

In some embodiments, the first coating 602-1 includes a non-conductive vacuum metallizing (NCVM) material. For instance, in some embodiments, the NCVM material of the first coating 602-1 has a high reflectance, such as a metallic luster or sheen, which allows for reflecting light internally through the light guide 406. In some embodiments, the NCVM material includes a metallic filler. In some embodiments, the NCVM material includes the metallic filler in the form of microflakes, nanoflakes, microparticles, nanoparticles, nanowires, nanotubes, or a combination thereof. In some embodiments, the metallic filler of the NCVM material in the composition has a dimension of about 10 μm to 5 μm, about 5 μm to 1 μm, or less than 1 μm. In some embodiments, the NCVM material includes aluminum, an aluminum alloy, titanium, a titanium alloy, cobalt, a cobalt alloy, nickel, a nickel alloy, copper, a copper alloy, zinc, a zinc alloy, silver, a silver alloy, gold, a gold alloy, indium, an indium alloy, platinum, a platinum alloy, silicon, a silicon alloy, or a combination thereof.

In some embodiments, a thickness of the first coating 602-1 ranges between 12 μm and 87 μm. For instance, in some embodiments, the thickness of the first coating 602-1 is between 12 μm and 87 μm, 12 μm and 50 μm, 14 μm and 85 μm, 14 μm and 48 μm, 17 μm and 82 μm, 17 μm and 45 μm, 19 μm and 80 μm, 19 μm and 43 μm, 22 μm and 77 μm, 22 μm and 40 μm, 24 μm and 75 μm, 24 μm and 38 μm, 27 μm and 72 μm, 27 μm and 35 μm, 29 μm and 70 μm, 29 μm and 33 μm, 31 μm and 68 μm, 34 μm and 65 μm, 36 μm and 63 μm, 39 and 60 μm, 41μ m and 58 μm, 43 μm and 56 μm, 46 μm and 53 μm, 48 μm and 51 μm, 50 μm and 87 μm, 52 μm and 85 μm, 55 μm and 82 μm, 57 μm and 80 μm, 60 μm and 77 μm, 62 μm and 75 μm, 65 μm and 72 μm, or 67 μm and 70 μm. In some embodiments, the thickness of the first coating 602-1 is at least 12 μm, at least 14 μm, at least 17 μm, at least 19 μm, at least 22 μm, at least 24 μm, at least 27 μm, at least 29 μm, at least 31 μm, at least 33 μm, at least 34 μm, at least 35 μm, at least 36 μm, at least 38 μm, at least 39 μm, at least 40 μm, at least 41 μm, at least 43 μm, at least 45 μm, at least 46 μm, at least 48 μm, at least 50 μm, at least 51 μm, at least 52 μm, at least 53 μm, at least 55 μm, at least 56 μm, at least 57 μm, at least 58 μm, at least 60 μm, at least 62 μm, at least 63 μm, at least 65 μm, at least 67 μm, at least 68 μm, at least 70 μm, at least 72 μm, at least 75 μm, at least 77 μm, at least 80 μm, at least 82 μm, at least 85 μm, or at least 87 μm. In some embodiments, the thickness of the first coating 602-1 is at most 12 μm, at most 14 μm, at most 17 μm, at most 19 μm, at most 22 μm, at most 24 μm, at most 27 μm, at most 29 μm, at most 31 μm, at most 33 μm, at most 34 μm, at most 35 μm, at most 36 μm, at most 38 μm, at most 39 μm, at most 40 μm, at most 41 μm, at most 43 μm, at most 45 μm, at most 46 μm, at most 48 μm, at most 50 μm, at most 51 μm, at most 52 μm, at most 53 μm, at most 55 μm, at most 56 μm, at most 57 μm, at most 58 μm, at most 60 μm, at most 62 μm, at most 63 μm, at most 65 μm, at most 67 μm, at most 68 μm, at most 70 μm, at most 72 μm, at most 75 μm, at most 77 μm, at most 80 μm, at most 82 μm, at most 85 μm, or at most 87 μm.

In some embodiments, the first coating 602-1 includes the NCVM material as a primer coat, a UV basecoat, an indium coat, a polyurethane middle coat, a UV topcoat, or a combination thereof.

Moreover, in some embodiments, the first coating using the NCVM material has a total thickness ranging between 57 μm and 87 μm. For instance, in some embodiments, the total thickness of the NCVM coating 602 is between 57 μm and 87 μm, 57 μm and 72 μm, 58 μm and 86 μm, 58 μm and 71 μm, 59 μm and 85 μm, 59 μm and 70 μm, 60 μm and 84 μm, 60 μm and 69 μm, 61 μm and 83 μm, 61 μm and 68 μm, 62 μm and 82 μm, 62 μm and 67 μm, 63 μm and 81 μm, 63 μm and 66 μm, 64 μm and 80 μm, 64 μm and 65 μm, 65 μm and 79 μm, 66 μm and 78 μm, 67 μm and 77 μm, 68 μm and 76 μm, 69 μm and 75 μm, 70 μm and 74 μm, 71 μm and 73 μm, 72 μm and 87 μm, 73 μm and 86 μm, 74 μm and 85 μm, 75 μm and 84 μm, 76 μm and 83 μm, 77 μm and 82 μm, 78 μm and 81 μm, or 79 μm and 80 μm.

In some embodiments, the total thickness of the NCVM coating 602 is at least 57 μm, at least 58 μm, at least 59 μm, at least 60 μm, at least 61 μm, at least 62 μm, at least 63 μm, at least 64 μm, at least 65 μm, at least 66 μm, at least 67 μm, at least 68 μm, at least 69 μm, at least 70 μm, at least 71 μm, at least 72 μm, at least 73 μm, at least 74 μm, at least 75 μm, at least 76 μm, at least 77 μm, at least 78 μm, at least 79 μm, at least 80 μm, at least 81 μm, at least 82 μm, at least 83 μm, at least 84 μm, at least 85 μm, at least 86 μm, or at least 87 μm. In some embodiments, the total thickness of the NCVM coating 602 is at most 57 μm, at most 58 μm, at most 59 μm, at most 60 μm, at most 61 μm, at most 62 μm, at most 63 μm, at most 64 μm, at most 65 μm, at most 66 μm, at most 67 μm, at most 68 μm, at most 69 μm, at most 70 μm, at most 71 μm, at most 72 μm, at most 73 μm, at most 74 μm, at most 75 μm, at most 76 μm, at most 77 μm, at most 78 μm, at most 79 μm, at most 80 μm, at most 81 μm, at most 82 μm, at most 83 μm, at most 84 μm, at most 85 μm, at most 86 μm, or at most 87 μm.

In some embodiments, the light guide 406 includes a second coating 602-2 adhered to the first coating 602-1. For instance, in some embodiments, the second coating 602-2 is disposed on an upper surface of the first coating 602-1. In some embodiments, the second coating 602-2 is configured to cover some or all of the upper surface of the first coating 602. For instance, in some embodiments, the first coating 602-1 is sealed from an environment using the second coating 602-2. However, the present disclosure is not limited thereto.

In some embodiments, the first coating 602-1 includes an organic water-based material. For instance, in some embodiments, the first coating 602-1 includes a water-based solvent or binder, such as acrylic or polyurethane. In some embodiments, the first coating 602-1 includes a homogenous blend of water and a surfactant. However, the present disclosure is not limited thereto. In some embodiments, the organic water-based material includes deionized water or distilled water.

In some embodiments, the organic water-based material of the first coating 602-1 has a water weight between 40 wt % and 96 wt %, 40 wt % and 68 wt %, 42 wt % and 94 wt %, 42 wt % and 66 wt %, 44 wt % and 92 wt %, 44 wt % and 64 wt %, 45 wt % and 91 wt %, 45 wt % and 63 wt %, 47 wt % and 89 wt %, 47 wt % and 61 wt %, 49 wt % and 87 wt %, 49 wt % and 59 wt %, 51 wt % and 85 wt %, 51 wt % and 57 wt %, 53 wt % and 83 wt %, 53 wt % and 55 wt %, 54 wt % and 82 wt %, 56 wt % and 80 wt %, 58 wt % and 78 wt %, 60 wt % and 76 wt %, 62 wt % and 74 wt %, 63 wt % and 73 wt %, 65 wt % and 71 wt %, 67 wt % and 69 wt %, 68 wt % and 96 wt %, 70 wt % and 94 wt %, 72 wt % and 92 wt %, 73 wt % and 91 wt %, 75 wt % and 89 wt %, 77 wt % and 87 wt %, 79 wt % and 85 wt %, or 81 wt % and 83 wt % of the first coating 602-1. In some embodiments, the water weight of the first coating 602-1 is at least 40 wt %, at least 42 wt %, at least 44 wt %, at least 45 wt %, at least 47 wt %, at least 49 wt %, at least 51 wt %, at least 53 wt %, at least 54 wt %, at least 55 wt %, at least 56 wt %, at least 57 wt %, at least 58 wt %, at least 59 wt %, at least 60 wt %, at least 61 wt %, at least 62 wt %, at least 63 wt %, at least 64 wt %, at least 65 wt %, at least 66 wt %, at least 67 wt %, at least 68 wt %, at least 69 wt %, at least 70 wt %, at least 71 wt %, at least 72 wt %, at least 73 wt %, at least 74 wt %, at least 75 wt %, at least 76 wt %, at least 77 wt %, at least 78 wt %, at least 79 wt %, at least 80 wt %, at least 81 wt %, at least 82 wt %, at least 83 wt %, at least 85 wt %, at least 87 wt %, at least 89 wt %, at least 91 wt %, at least 92 wt %, at least 94 wt %, or at least 96 wt %. In some embodiments, the water weight of the first coating 602-1 is at most 40 wt %, at most 42 wt %, at most 44 wt %, at most 45 wt %, at most 47 wt %, at most 49 wt %, at most 51 wt %, at most 53 wt %, at most 54 wt %, at most 55 wt %, at most 56 wt %, at most 57 wt %, at most 58 wt %, at most 59 wt %, at most 60 wt %, at most 61 wt %, at most 62 wt %, at most 63 wt %, at most 64 wt %, at most 65 wt %, at most 66 wt %, at most 67 wt %, at most 68 wt %, at most 69 wt %, at most 70 wt %, at most 71 wt %, at most 72 wt %, at most 73 wt %, at most 74 wt %, at most 75 wt %, at most 76 wt %, at most 77 wt %, at most 78 wt %, at most 79 wt %, at most 80 wt %, at most 81 wt %, at most 82 wt %, at most 83 wt %, at most 85 wt %, at most 87 wt %, at most 89 wt %, at most 91 wt %, at most 92 wt %, at most 94 wt %, at most 96 wt %, or at most 98 wt %.

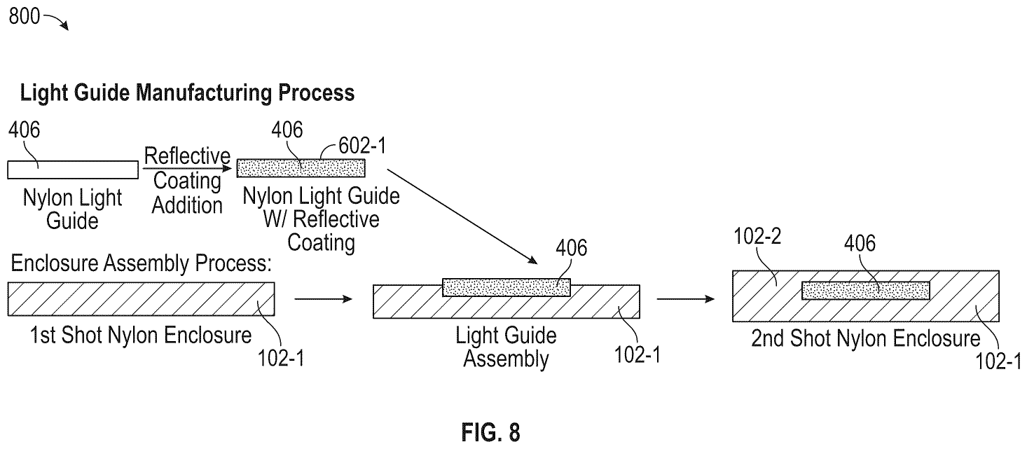

Referring to FIG. 8, in some embodiments, the present disclosure is directed to providing a method of manufacturing an optical device (e.g., method 800 of FIG. 8, etc.), such as optical device 100 of FIG. 2.

In some embodiments, the method 800 includes a first process that forms a first portion of a frame 102 of the optical device 100. For instance, in some embodiments, the first process includes providing a first shot of a semi-translucent material to a mold to produce a first portion of the frame 102-1 of the optical device 100. In some embodiments, the first portion of the frame 102 includes a surface, a cavity, a region, a groove, or the like that is configured to accommodate a circuit component 200, such as a light source 404. In some embodiments, the method 800 includes disposing some or all of the circuit component at the surface, the region, the cavity, the groove, or the like, which allows for the frame 102 to house the circuit component 200. For instance, in some embodiments, a flexible printed circuit board that includes a light source 404 is inserted into the cavity of the first portion of the frame 102 of the optical device 100. Furthermore, in some embodiments, the method 800 includes disposing a light guide 406 on the circuit component 200, such as on or near the light source 400. Moreover, in some embodiments, the light guide 404 includes one or more coatings 602. In some embodiments, a respective coating 602 in the one or more coatings is configured to reduce light leakage to a surrounding environment, such as through a material of the frame 102. Moreover, in some embodiments, the method 800 includes a second process that forms a second portion of the frame 102. For instance, in some embodiments, the second process includes providing a second shot of the semi-translucent material over a portion of the light guide 406 to secure the light guide 406 within the first portion of the frame 102 of the optical device 100. From this, the method 800 provides the optical device that includes the light guide 406 housed by the frame 102, allowing for light emitted by the light source to traverse through the light guide 406 with little to no leaking of light through surfaces other than the light guide 406.

All references cited herein are incorporated herein by reference in their entirety and for all purposes to the same extent as if each individual publication or patent or patent application was specifically and individually indicated to be incorporated by reference in its entirety for all purposes.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An optical device comprising:
a semi-transparent frame comprising:
a light source configured to display a status of the optical device;
a light guide configured to transmit light from the light source to an exterior surface of the semi-transparent frame; and
a first coating adhered to the light guide, wherein the first coating is configured to limit leakage of the light from the light source to the semi-transparent frame such that only the light guide is illuminated, wherein the first coating is a type selected from a group consisting of a low volatile organic compound (LVOC) coating, a non-conductive vacuum metallizing (NCVM) coating, and an organic water-based (WB) coating.

2. The optical device of claim 1, wherein a thickness of the first coating ranges between 12 μm and 87 μm.

3. The optical device of claim 1, wherein the NCVM type of coating comprises a primer coat, UV basecoat, indium coat, polyurethane middle coat, and UV topcoat with a total thickness ranging between 57 μm and 87 μm.

4. The optical device of claim 1, wherein the LVOC type of coating comprises a metallic ranging between 12 μm and 16 μm.

5. The optical device of claim 4, wherein the LVOC type of coating comprises a PU topcoat with a thickness ranging from 24 μm and 26 μm.

6. The optical device of claim 1, wherein the semi-transparent frame comprises a second coating adhered to the first coating.

7. The optical device of claim 1, wherein the LVOC type of coating comprises a metallic primer between 12 μm and 16 μm and a PU topcoat between 15 μm and 20 μm.

8. The optical device of claim 6, wherein the second coating is a LVOC type of coating that comprises a metallic primer between 12 μm and 16 μm and a PU topcoat between 15 μm and 20 μm.

9. The optical device of claim 1, wherein the light guide emits light on a surface that faces a user's face when the optical device is donned.

10. The optical device of claim 1, wherein the light source is configured to convey information about the optical device to a user.

11. The optical device of claim 1, wherein the light source comprises a light emitting diode.

12. The optical device of claim 1, wherein the light source comprises a substrate that limits light leakage from being presented on the opposite direction of where the light guide sends light.

13. The optical device of claim 1, wherein the light guide is separated by an adhesive layer that limits light leakage between the light guide and a substrate.

14. The optical device claim 1, wherein an exterior surface of the light guide has a size between 0.35 mm and 3.5 mm.

15. The optical device claim 1, wherein the exterior surface of the light guide has a size between 2.5 mm and 0.65 mm.

16. The optical device of claim 1, wherein the light guide comprises a nylon material.

17. The optical device of claim 1, wherein the optical device is a pair of smart glasses, an augmented reality headset, a virtual reality headset, a mixed-reality headset, a head-mounted display, or a combination thereof.

18. A method of manufacture, wherein the method comprises:
providing a first shot of a semi-translucent material to a mold to produce a first portion of a frame of an optical device;
inserting a flexible printed circuit board that includes a light source into a cavity of the first portion of the frame of the optical device;
attaching a light guide that includes a coating that reduces light leakage to surrounding translucent material; and
providing a second shot of the semi-translucent material over a portion of the light guide to secure the light guide within the first portion of the frame of the optical device to thereby produce a frame for an optical device that includes the light guide.

19. The method of claim 18, wherein the coating is a type selected from a group consisting of a low volatile organic compound (LVOC) coating, a non-conductive vacuum metallizing (NCVM) coating, and an organic water-based (WB) coating.

20. The method of claim 18, wherein the coating comprises a thickness between 12 μm and 87 μm.
